(19) United States
(12) Patent Application Publication
(10) Pub. No.: US 2004/0081096 A1
(43) Pub. Date: Apr. 29, 2004

(54) Method and device for extending usable lengths of fibre channel links

(75) Inventor: Kreg A. Martin, Los Gatos, CA (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Brocade Communications Systems, Inc.

(21) Appl. No.: 10/281,871

(22) Filed: Oct. 28, 2002

(51) Int. Cl. G01R 31/08; H04L 12/28

(52) U.S. Cl. 370/231; 370/392

(57) ABSTRACT

A device for converting between the trunked and untrunked transmission of Fibre Channel frame data and for providing connections using longer distance links is described. During conversion, the device manages the flow of frame data in both the egress (from Fibre Channel ports to a non-Fibre Channel port) and ingress (from a non-Fibre Channel port to Fibre Channel ports) directions. In the egress direction, the device operates as a FIFO to transmit all frames received from the Fibre Channel ports to the non-Fibre Channel ports. In the ingress direction, every frame received by the non-Fibre Channel port is stored in one of up to four storage segments based on the frame data's virtual circuit and path number identifiers. Frames are transmitted out of each storage segment in the order in which they are received therein. The device may be a stand-alone device. The device may also be incorporated into a Fibre Channel switch or other apparatus that connects to a Fibre Channel network or switch. During long haul operation, ingress frames are buffered in one or two storage or buffered segments and egress frames are transmitted using FIFO segments. The buffered segments are large, providing a large number of credits to allow longer distance links. The device may be configurable between conversion and long haul operations.

### CROSS-REFERENCE TO RELATED APPLICATIONS

This application is related to and incorporates by reference, U.S. patent applications, Ser. No. 09/872,412, entitled “Link Trunking And Measuring Link Latency In Fibre Channel Fabric,” by David C. Banks, Kreg A. Martin, Shunjia Yu, Jieming Zhu and Kevan K. Kwong, filed Jun. 1, 2001; Ser. Number 10/062,861 entitled “Methods and Devices for Converting Between Trunked and Single-Link Data Transmission in a Fibre Channel Network,” by Kreg A. Martin, filed Jan. 31, 2002 and Ser. No. 10/207,361 entitled “Cascade Credit Sharing For Fibre Channel Links” by Kreg A. Martin and Shahe Krakirian, filed Jul. 29, 2002.

### BACKGROUND OF INVENTION

1. Field of the Invention

The invention relates generally to data transmission in a Fibre Channel network and, more particularly but not by way of limitation, to techniques for extending the usable distance of Fibre Channel Links.

2. Description of the Related Art

As used herein, the phrase “Fibre Channel” refers to the Fibre Channel family of standards promulgated by the American National Standards Institute as ANSI X.3/T11. In general, Fibre Channel defines a high speed serial transport system that uses a hierarchically structured information exchange protocol consisting of frames, sequences and exchanges. A “frame” is the atomic unit of data transmission between two communicating devices. A “sequence” is a set of one or more related data frames transmitted unidirectionally from one device to another device within an exchange. An “exchange” is the basic construct for coordinating the transfer of information between communicating devices during higher layer protocol operations such as Small Computer System Interface (SCSI) and Transport Control Protocol/Internet Protocol (TCP/IP).

Referring to FIG. 1, communication between end devices such as server 100, storage unit 105, storage units 110 and loop 115 (itself comprised of devices, not shown) is mediated by “fabric” 120, a term which refers to one or more operatively coupled Fibre Channel switches, e.g., 125, 130 and 135.

One technique to transmit a high-speed stream of frames between two devices is to use a single link that supports the desired bandwidth. For example, if data needs to be moved from device-1 to device-2 at 6 Gigabits per second (Gbps), the two devices could be coupled by a single 6 Gbps link (though this speed is not currently available through a Fibre Channel port).

Another technique to transmit a high-speed stream of frames between two devices is to use trunking. As described in U.S. patent application Ser. No. 09/872,412, trunking is a technique for sending a stream of frames across multiple links between two devices such that: (1) nearly all of the combined available bandwidth between the two devices can be used; and (2) frames are delivered to the receiving device in order. For example, if data needs to be moved from device-1 to device-2 at 6 Gigabits per second (Gbps), the two devices could be coupled by 3 trunked 2 Gbps links or 6 trunked 1 Gbps links. Trunking allows the creation of logical high-speed links from a plurality of slower-speed links without violating the in-order delivery requirement of most Fibre Channel devices.

One concern for high-speed communication networks, such as Fibre Channel, is the allowable distance of a particular link between devices. In Fibre Channel the underlyng transport medium can allow extremely long distances, in the hundreds of kilometers. However, it is extremely difficult to maintain full data rate transmission on long links because of the credit-based flow control used in Fibre Channel. As explained more fully in “Credit Sharing For Fibre Channel Links With Multiple Virtual Channels” Kreg A. Martin and David C. Banks, filed Jul. 29, 2002, Ser. No. 10/207,541, which is hereby incorporated by reference, to maintain full data rate transmission, buffer memory size must grow as link length increases. But this must be balanced with the expense of adding the additional buffer memory, which would often go unused and thus be a waste of resources. Because of this tradeoff, link lengths have been limited. A cost effective, flexible way to alleviate the problem is desirable to allow improved longer distance communication.

### SUMMARY OF INVENTION

Embodiments according to the present invention provide a simple, cost-effective way to lengthen the usable length of network links, particularly Fibre Channel Links.

A device according to the present invention provides a series of network ports, which ports may be trunked if desired. The device is arranged with a transmit portion and a receive portion, each coupled to the network ports. The receive portion contains a large buffer memory area which can be configured in many different arrangements. The transmit portion is internally connected to the receive portion, thus allowing all of the network ports use of the large buffer memory.

In one configuration of the device, a number of the network ports are connected to local network devices and the remaining network ports are connected to a network device, or devices, located at a long distance. The buffer memory is configured to predominantly be allocated to the long distance network ports. This provides the capability to allocate a large number of credits to the long distance network links, allowing them to run at a much higher speed than if the buffer memory was allocated more evenly.

In an alternate embodiment of the device, the transmit and receive portions are connected to a high speed port, rather than internally to each other. This allows the device to be used for connecting trunked, lower speed network devices to a single-link high speed device. The connection of the receive and transmit portions to the high speed port or to each other is programmable. By allowing this programmability, the device can be used for multiple functions, further reducing costs and providing for more economical network connections over longer distance links.

### BRIEF DESCRIPTION OF THE DRAWINGS

FIG. 1 shows, in block diagram form, an illustrative prior art Fibre Channel network.

FIG. 2A shows, in block diagram form, a first configuration of a device in accordance with one embodiment of the invention.

FIG. 2B shows, in block diagram form, a second configuration of the device of FIG. 2A.

FIG. 3 shows an illustrative internal frame format for a device in accordance with one embodiment of the invention.

FIG. 4A shows, in block diagram form, the device of FIG. 2A in one operational configuration.

FIG. 4B shows, in block diagram form, the device of FIG. 2B in one operational configuration.

FIG. 4C shows, in block diagram form, the device of FIG. 2B in a second operational configuration.

FIG. 5 shows a flow chart of a data frame egress operation for a device in accordance with FIG. 4A.

FIG. 6A shows, in block diagram form, the device of FIG. 2A in another operational configuration.

FIG. 6B shows, in block diagram form, the device of FIG. 2B in another operational function.

FIG. 7A shows, in block diagram form, a first configuration of a device in accordance with yet another embodiment of the invention.

FIG. 7B shows, in block diagram form, a second configuration of the device of FIG. 7A.

FIG. 8A shows, in block diagram form, a Fibre Channel network in accordance with one embodiment of the invention.

FIG. 8B shows, in block diagram form, a Fibre Channel network in accordance with a second embodiment of the invention.

FIG. 9 shows, in block diagram form, a Fibre Channel network in accordance with another embodiment of the invention.

FIG. 10A shows, in block diagram form, a Fibre Channel network in accordance with an embodiment of the invention wherein two switches are connected by a long haul trunk.

FIG. 10B shows, in block diagram form, a Fibre Channel network in accordance with an embodiment of the invention wherein three switches are connected by non-trunked long haul links.

FIG. 10C shows, in block diagram form, a Fibre Channel network in accordance with an embodiment of the invention wherein a switch is connected to two devices by long haul links.

FIG. 11 shows, in block diagram form, a Fibre Channel switch in accordance with an embodiment of the invention.

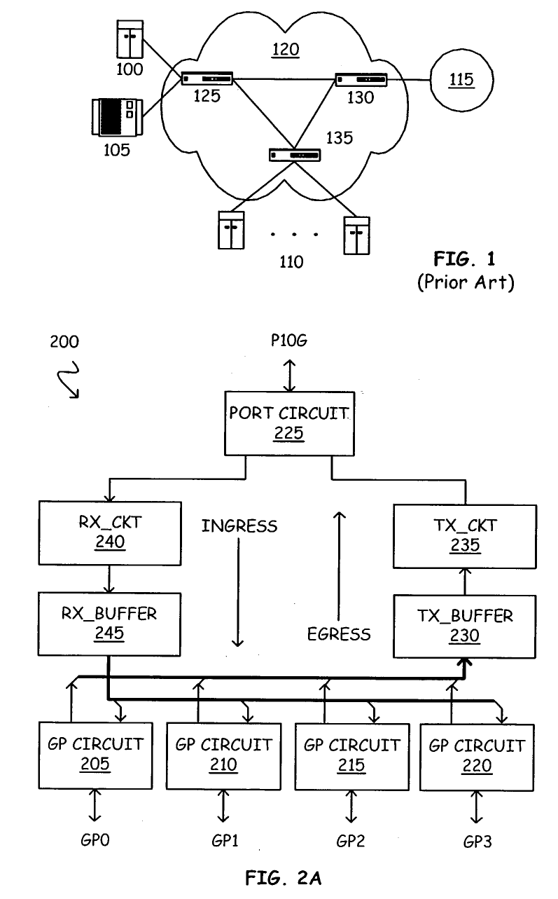

### DETAILED DESCRIPTION

The invention relates generally to data transmission and, more particularly but not by way of limitation, to devices for providing improved longer distance communication of data frames. The following embodiments of the invention, described in terms of a Fibre Channel network, are illustrative only and are not to be considered limiting in any respect.

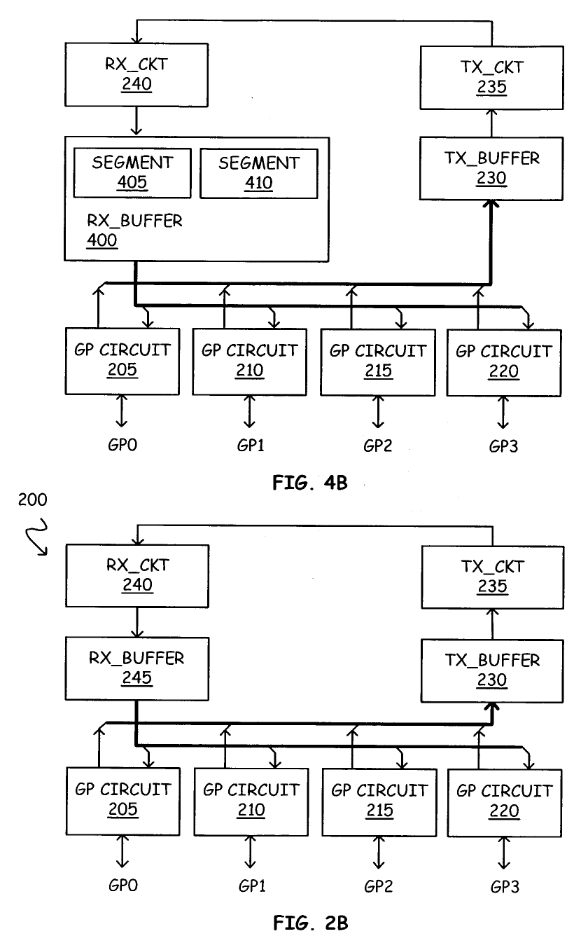

FIG. 2A shows a high-level block diagram for a first configuration of a device in accordance with one embodiment of the invention. As shown, device 200 may be communicatively coupled to a fabric (not shown) by up to four Fibre Channel gigabit port circuits 205 through 220 (identified as ports GP0 through GP3 or, collectively GP ports) and to one high-speed port circuit 225 (identified as port P10G). For example, GP ports 205 through 220 may each operate independently at 1, 2 or 3 gigabits per second (Gbps) and port P10G 225 may implement a four-lane 10 Gbps attachment unit interface (XAUI) circuit. During conversion operations in accordance with the invention, device 200 may manage the flow of frames in two directions: egress (from GP ports to port P10G) and ingress (from port P10G to GP ports).

In the egress direction, device 200 operates as a FIFO transmitting all frames received from GP ports 205-220 through transmit buffer TX_BUFFER 230 and transmit circuit TX_CKT 235 to port P10G 225 in exactly the same order as they are received at the GP ports. In this mode of operation, device 200 does not prioritize frame traffic based on virtual circuit identifier (VC_ID) or path number (PN). In particular, the PN of an egress frame is assigned by TX_BUFFER 230 based on the source GP and passed through TX_CKT 235 to port P10G 225. As used herein, a PN identifies a bi-directional data path through device 200 and VC identifies a specific virtual (i.e., logical) circuit within a stream of frames associated with a single PN.

In the ingress direction, RX_BUFFER 245 stores every frame received by port P10G 225 (through RX_CKT circuit 240) in one of up to four segments, mapping each segment to one or more destination GP ports. Specifically, frames can be mapped to the one or more segments within RX_BUFFER 245 based on VC and PN identifiers. Thus, because frames are routed to RX_BUFFER 245 segments based on VC and PN and further because frames are transmitted out of each segment in the order in which they are received therein (that is, each segment may be organized as a FIFO), frame ordering within VC and PN can be maintained.

In one embodiment, port P10G 225 and each GP port (205-220) may be independently configured to operate as an E_Port (a label used to identify a switch-to-switch, or intra-fabric, port) or F_Port (a label used to identify a fabric port coupled to a single device such as a server, workstation, database or storage unit). Each port circuit, therefore, may independently utilize Fibre Channel ARB primitives before transmitting a data frame to identify the relevant virtual channel; as described in Ser. No. 09/929,627 entitled “Quality of Service Using Virtual Channel Translation” by David C. Banks and Alex Wang, filed Aug. 13, 2001, which is hereby incorporated by reference; and VC_RDY primitives for flow control to indicate if the particular virtual channel can receive or transmit data packets. In one particular embodiment, F_Ports operate with a single VC identifier (e.g., VC_ID=0) while E_Ports support up to 12 virtual circuits (VC_ID=0 to 11). In addition, port P10G 225's ARB and VC_RDY messages may have an associated Path Number (PN) and Virtual Channel (VC), while each GP port 205-220 may have associated only a VC.

In the embodiment of FIG. 2A:

1. Port circuit 225 implements the functionality of a bi-directional four-lane XAUI port as defined by the developing ANSI T11 10GFC standard, which references the IEEE P802.3ae standard and provides enhancements and modifications for Fibre Channel operation. Port circuit 225 may further comprise SERializing/DESerializing (SERDES) circuitry to receive serial input and to provide serial output.

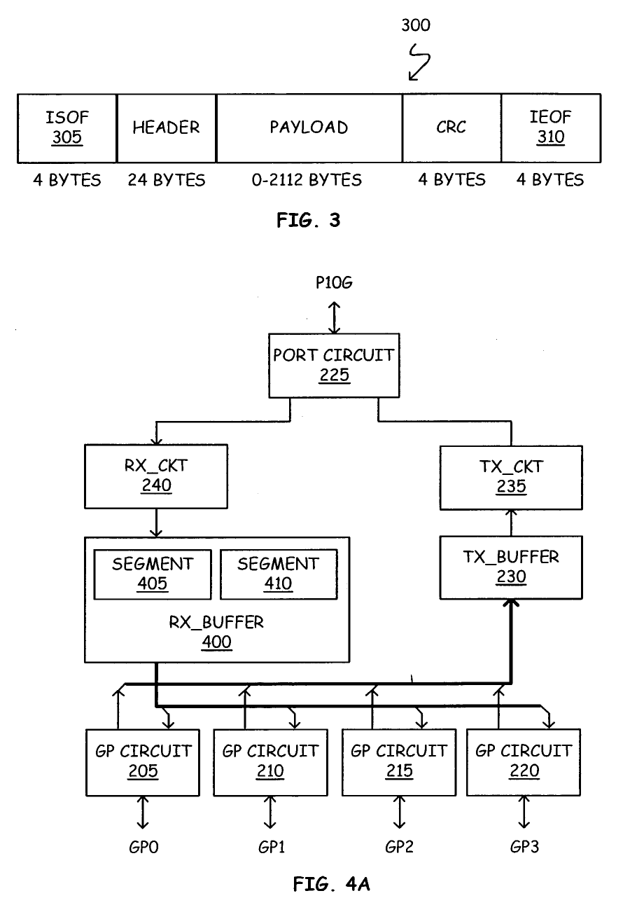

2. Receive circuit RX_CKT 240 provides an interface between port circuit 225 and receive buffer RX_BUFFER 245. Inter alia, RX_CKT 240 (1) converts ingress data frames into device specific format (see discussion below and FIG. 3), (2) contains an elasticity FIFO to synchronize data received from port circuit 225 at the port circuit's clock rate, to the clock rate of the buffer RX_BUFFER 245, (3) performs CRC check on received frames and, in the case of an error, invalidates the frame, (4) performs frame size under-run and over-run checks and, in the case of an error, tags the frame with an error code of “abort frame,” and (5) captures received ARB/VC ordered sets preceding a frame to determine the associated virtual channel number that is passed to receive buffer RX_BUFFER 245.

3. Receive buffer RX_BUFFER 245 provides segmented buffer space for frames received from port circuit 225. Inter alia, RX_BUFFER 245 (1) buffers data received from port circuit 225, (2) transmits buffered frames to a designated GP port based on path number, and (3) checks aging of buffered frames and invalidates those frames that are timed out. In one particular embodiment, RX_BUFFER 245's segmented buffer comprises 1.3 million bytes of data storage and has a bandwidth of 20.4 Gbps when operated at a clock speed of 159.375 MHz (see discussion below and Table 6).

4. Fibre channel gigabit ports 205-220 provide conventional Fibre Channel port functionality. Each port may be separately configured to operate as an independent port or as one port in a trunked group of ports. In addition, each port may incorporate SERDES circuitry.

5. Transmit buffer TX_BUFFER 230 provides speed matching buffering for frames received by any of GP ports 205-220 (at a GP port clock rate) on their way to port circuit 225 (operated at the TX_CKT 235 and port circuit 225's clock rate). TX_BUFFER 230 receives and transmits all data frames using device 200's internal frame format (see discussion below and FIG. 3).

6. Transmit circuit TX_CKT 235 provides an interface between transmit buffer 230 and port circuit 225. Inter alia, TX_CKT 235 (1) converts egress data frames from internal device format to standard Fibre Channel format (see discussion below and FIG. 3), (2) performs CRC check on out-going frames and, in the case of an error, invalidates the frame, and (3) when enabled, transmits ARB/VC ordered sets preceding a frame to identify the associated virtual channel.

The RX_BUFFER 245 and TX_BUFFER 230 are configured to enable in-order delivery of frames. Generally the RX_BUFFER 245 is organized physically as a single FIFO or circular buffer so that frames are stored in-order. Egress logic then monitors the GP ports 205-220 for virtual channel credit availability and properly reads the frames from the RX_BUFFER 245 in-order for each GP port 205-220. The TX_BUFFER 230 is preferably organized as four buffers, one per GP port, each buffer being a circular buffer. A separate ordering FIFO is used to record order entry of frames into the four buffers. Egress from the TX_BUFFER 230 is based on entries from the ordering FIFO.

Frames passing though device 200 may be formatted in accordance with FIG. 3 and routed using Fibre Channel ARB and VC_RDY primitives. In one embodiment, device 200's internal frame format 300 is the same as the standard Fibre Channel frame format except for its start of frame (ISOF field 305) and end of frame (IEOF field 310) fields. Table 1 defines ISOF field 305 and Table 2 defines IEOF field 310. Tables 3 through 5 illustrate the Fibre Channel ARB and VC_RDY primitives as used in the preferred embodiment in E_Port mode. The ARB and VC_RDY primitives are not defined by the ANSI standards for E_Port mode use, but are used in the preferred embodiment in that mode for the operations described herein.

TABLE 1
Illustrative ISOF Field Definition

| Bits | Function |
|---|---|
| 31:28 | The one's complement of bits 27:24. This value is checked before |
| | a frame is transmitted out of device 200 and the frame is |
| | invalidated if there is a mismatch. |
| 27:24 | Encodes the Fibre Channel start of frame (SOF) type. |
| 23:0 | Reserved. |

TABLE 2
Illustrative IEOF Field Definition

| Bits | Function |
|---|---|
| 31:30 | Frame error code: NO_ERR if no error is detected; INV_FRM to signify an |
| | invalid frame because, for example, of a frame CRC error, EOF type |
| | mismatch, RX_BUFFER 245 time out; and ABRT_FRM to signify an abort |
| | frame error because, for example, the frame size is less than 36 bytes or |
| | greater than 2148 bytes or because of a device 200 internal data path parity |
| | error. |
| 29:27 | The one's complement of bits 26:24. This value is checked before a frame is |
| | transmitted out of device 200 and the frame is invalidated if there is a |
| | mismatch. |
| 26:24 | Encodes the Fibre Channel end of frame (EOF) type. |
| 23:22 | Reserved. |
| 21:20 | Path Number (PN) which generally equates to Source Fibre Channel port |
| | (GP0-GP3) identifier. When a frame is received by one of GP ports 205-220, |
| | this field identifies the port. When a frame is received by port P10G 225 |
| | in the trunked mode, this field is forced to ‘00b.’ When a frame is received |
| | by port P10G 225 in the non-trunked mode, this field identifies which port in |
| | the externally transmitting device sent the frame. |
| 19:16 | Virtual channel identifier. |
| 15:0 | Encodes the sequence number associated with the frame. The sequence |
| | number is used by RX_BUFFER 245 to ensure that frames associated with a |
| | given source port and virtual channel are transmitted in the same order as |
| | they are received. For each source port and virtual channel, this field can be |
| | incremented by one for each frame received by RX_BUFFER 245. Other |
| | functional blocks within device 200 may ignore this field. |

TABLE 3
ARB and VC_RDY primitives Transmitted/Received by Ports
GP0-GP3 in E_Port Mode

| | |
|---|---|
| Primitive | Format |

| | | | | |
|---|---|---|---|---|
| ARB | K28.5 | D20.4 | VC_ID | VC_ID |
| VC_RDY | K28.5 | D21.7 | VC_ID | VC_ID |

TABLE 4
ARB and VC_RDY primitives Transmitted/Received by
Port P10G in E_Port Mode

| | |
|---|---|
| Primitive | Format |

| | | | | |
|---|---|---|---|---|
| ARB | K28.2 | D20.4 | PN_VC | PN_VC |
| VC_RDY | K28.2 | D21.7 | PN_VC | PN_VC |

Where the PN_VC format can be an 8-bit field defined as shown in Table 5.

TABLE 5
PN_VC Field Format

| Bits | Function |
|---|---|
| 7:6 | Path number. |
| 5:4 | Reserved. |
| 3:0 | Virtual channel identifier. |

For the particular embodiment of FIG. 2A, Table 6 shows typical clock speeds and throughput rates for each GP port 205-220 and port P10G 225. (Each of GP0-GP3 may have its clock speed set independent of the other ports.)

TABLE 6
Supported Data Rates for the Embodiment of FIG. 2

| Fibre | | | |
|---|---|---|---|
| Channel | Fibre Channel Port | Data Rate Per GP | Combined GP Port |
| Port Type | Clock (MHz) | Port (Gbps) | Data Rate (Gbps) |
| 1 Gigabit | 53.126 | 0.85 | 3.4 |
| 2 Gigabit | 106.25 | 1.7 | 6.8 |
| 3 Gigabit | 159.375 | 2.55 | 10.2 |

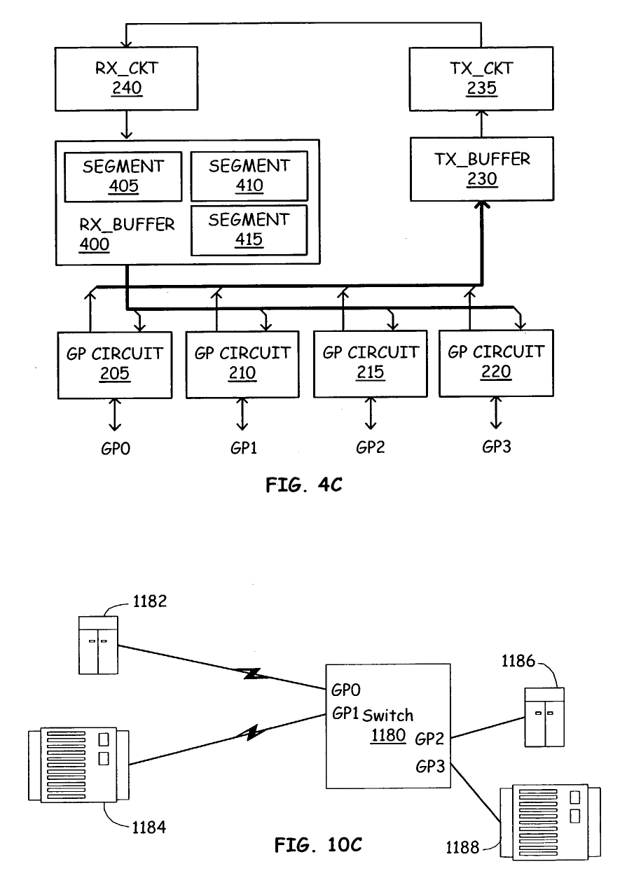

Referring to FIG. 4A, in one embodiment device 200 may be configured such that all four GP ports 205-220 are trunked and port P10G 225 is coupled to a 10 Gbps XAUI compatible device. Accordingly, all ports (GP0-GP3 and P10G) are configured as E_Ports and the memory associated with RX_BUFFER 400, which may be implemented as one physical memory space, may be partitioned into two segments:

1. A relatively large segment 405 for ingress frames belonging to a specified virtual circuit. Frame data is throttled into segment 405 in accordance with Fibre Channel “credit” flow control mechanisms. Preferably the large segment 405 is the remainder of the RX_BUFFER 400 after providing space for a small segment 410 described next. Receive buffers for the specified virtual circuit are allocated in segment 405 and advertised to the external transmitting device. Because segment 405 advertises buffer space, it is referred to as a buffered segment. (Additional receive buffers residing in a device(s) coupled to one or more of GP ports 205-220 may also be advertised to the external transmitting device.)

2. A relatively small segment 410 that has only a small number of any allocated receive buffers but does not advertise or indicate any credits associated with those buffers. Because segment 410 does not advertise buffer space, it is referred to as a unbuffered segment. Segment 410 may be used for ingress frames belonging to all other virtual circuits. The amount of the RX_BUFFER 400 reserved for the small segment 410 is based on the number of credits for the GP ports 205-220, the frame rates of the GP Ports 205-220 and the P10G port 225, the number of frames temporarily buffered, the number of RDYs sent and other relevant factors. In most cases the size is less than 100 k bytes.

Segment 410 can act as a temporary FIFO: receive buffers for the associated virtual circuits are allocated in the appropriate devices coupled to GP ports 205- 220, and flow control between the externally transmitting device and these GP coupled devices ensures that the external device sends a frame to this segment only if the GP coupled device has a receive buffer for it. (This mechanism implements the Fibre Channel proscribed “credit” system of flow control.) A frame in segment 410 is forwarded to the appropriate GP port coupled device as soon as possible so that it does not block other frames behind it in the segment. Accordingly, segment 410 should have a higher priority for transmitting data through Fibre Channel port circuits 205-220 than segment 405. In addition, if the combined GP port data rate (see Table 6) is less than the 10 Gigabit rate of the P10G port 225, segment 410 should be large enough to provide temporary buffering to accommodate for the speed difference. For example, if each GP port is running at 2 Gbps, the combined GP port data rate is approximately 6.8 Gbps versus 10.2 for the P10G port-a ratio of about 2:3 (see Table 6). If 4 virtual circuits are mapped to segment 410 and the devices coupled to GP ports 205-225 advertise 16 buffers per virtual circuit, then the externally transmitting device can send up to 64 maximum sized buffers into segment 410 at a rate of 10.2 Gbps. However, frames can only be sent from segment 410 at a rate of 6.8 Gbps. Thus, the minimum size for segment 410 to prevent an overrun is (64×⅓), or 21.3 maximum frame sizes (plus some margin to accommodate for a minimum inter-frame gap size at port P10G 225 and a maximum frame gap size at GP ports 205-220).

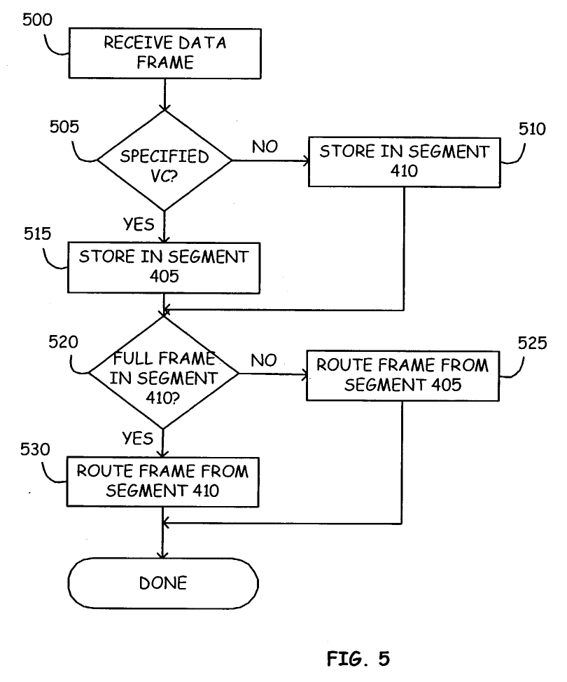

One method to process ingress data frames in accordance with the embodiment of FIG. 4A is shown in FIG. 5. As a frame is received through port circuit 225 (block 500), a determination is made as to which virtual circuit the frame is associated with. If the frame is not associated with the specified virtual circuit (the “no” prong of diamond 505), it is buffered in segment 410 (block 515). If the frame is associated with the specified virtual circuit (the “yes” prong of diamond 505), it is buffered in segment 405 (block 515). If segment 410 does not contain a full frame (the “no” prong of diamond 520), a frame from segment 405 is routed to the appropriate Fibre Channel port (block 525). If segment 410 does contain a full frame (the “yes” prong of diamond 520), a frame from segment 410 is routed to the appropriate Fibre Channel port (block 530). While the illustrated process indicates the operations on a single frame, it is understood that this process is repeated as necessary until all received frames have been routed to the appropriate Fibre Channel port.

Additionally, it is understood that frames can be provided from segment 410 before segment 405 even if a full frame has not been received because the frame rate from port P10G 225 is higher than the combined frame rates for GP ports 205-220 when the GP ports 205-220 are at 1 and 2 Gbps rates. In those cases the test of diamond 520 could be changed to “Frame being written to segment 410?” Additional priority variations can also be developed.

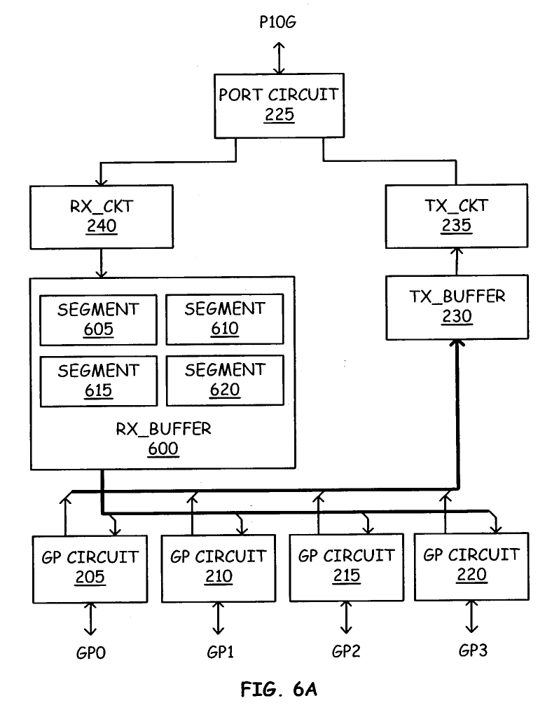

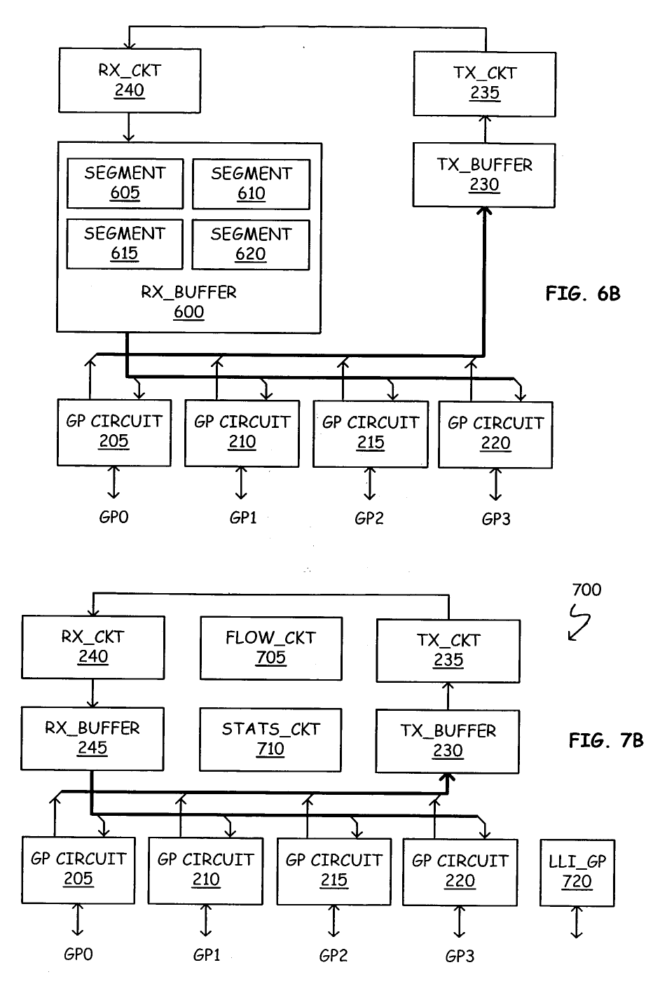

Referring to FIG. 6A, in another embodiment of device 200, port P10G 225 is configured as an E_Port and each of GP ports 205-220 are configured as non-trunked F_Ports. In this embodiment, the memory associated with RX_BUFFER 600 may be partitioned into four segments 605, 610, 615 and 620. In this configuration, each of segments 605-620 implement a FIFO structure and are dedicated to an associated Fibre Channel port. (One of ordinary skill in the art will recognize that two or more of segments 605-620 may be physically embodied in a single memory device.) An egress frame received by device 200 in this configuration is transmitted through port P10G 225 with its PN value using the Fibre Channel ARB primitive. An ingress frame received by device 200 in this configuration is passed through with its PN value and transmitted by the associated Fibre Channel port.

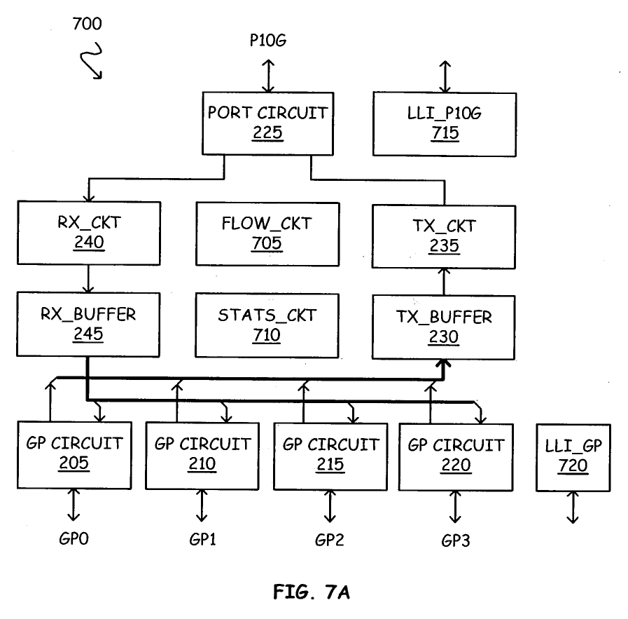

While FIGS. 4A and 6A illustrate two embodiments of device 200, one of ordinary skill in the art will recognize not all functions needed to implement a viable device have been shown. For example, it will be recognized that multiple clocking signals may be needed to implement device 200 but that the existence and variety of such clocking signals (forming different clock domains) would be known to those of ordinary skill. In addition, various other embodiments of device 200 may include additional circuits. Referring to FIG. 7A, for example, device 700 designed to implement the functions described herein may also include one or more circuits such as:

1. Flow control management circuit FLOW_CKT 705 for managing buffer-to-buffer credits (the Fibre Channel flow mechanism) for both the egress and ingress directions.

2. Statistics acquisition and monitoring circuit STAT_CKT 710 for recording frame traffic statistics such as, for example, the number of frames passing though a specified Fibre Channel port, the number of CRC errors occurring on frames passing through a specified port, etc.

3. Low-level port circuit LLI_P10G 715 for control of the management data (MDIO) interface in accordance with the IEEE 802.3ae standard and the sideband signals of the 10G PHY layer components.

4. Low-level Fibre Channel port interface LLI_GP 720 for communication with internal status and control registers within each Fibre Channel port circuit 205-220.

It will be recognized by one of ordinary skill in the art that a device in accordance with the invention may include more or fewer than four Fibre Channel port circuits and, perhaps, more than one high-speed circuit such as port circuit 225. It will also be recognized by those of ordinary skill in the art that while port circuit 225 has been described in terms of an IEEE compliant XAUI interface, it may be virtually any interface such as XGMII. Similarly, it will be recognized that any device such as device 200 may utilize special registers (e.g., “global registers”) to identify certain operational characteristics of the components therein. For example, there may be registers to indicate the path number for each GP port acting as a data fame source (egress operations) and additional registers to identify the path number for each GP port acting as a data frame destination (ingress operations).

FIG. 2B shows a high level block diagram of a second configuration of a device in accordance with one embodiment of the invention. As illustrated in device 200 very similar to the device 200 of FIG. 2A except that the TX_CKT 235 is directly connected to the RX_CKT 240 rather than being connected to the port circuit 225. This alternate connection of the TX_CKT 235 is controlled by a software configuration bit in the device 200 so that the connection can be readily changed based on the specific use of the device 200. As shown in FIG. 2B, the device 200 may be coupled to a fabric by up to four Fibre Channel Gigabit port circuits 205 through 220 (identified as ports GP0 through GP3 or, collectively GP ports). In this case frames received by one of the GP circuits 205-220 is provided to the TX_BUFFER 230, while frames being transmitted from the GP circuits 205-220 are provided from the RX_BUFFER 245 to the GP circuits 205-220. In this configuration also the path numbers are assigned to the frames generally based on the source GP and passed through the TX_CKT 235 to the RX_CKT 240. In general, the TX_BUFFER 230, TX_CKT 235, RX_CKT 240, and RX_BUFFER 245 operate as in the configuration of FIG. 2A, so the descriptions of those particular circuits provided above with regard to the embodiment of FIG. 2A are also generally applicable to FIG. 2B.

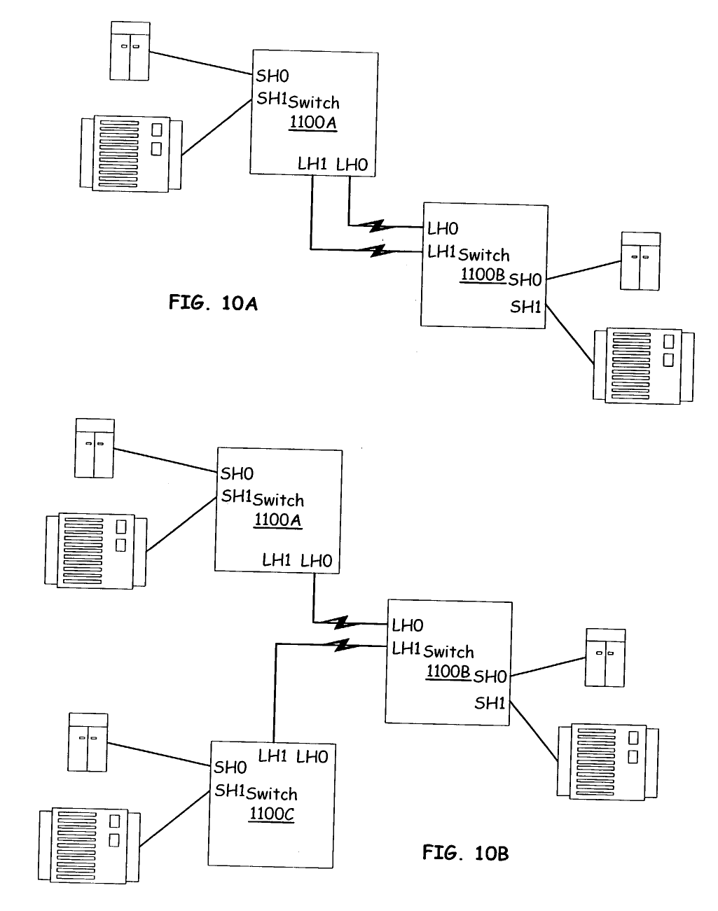

FIG. 4B then illustrates a configuration of the device 200 in the long haul configuration of FIG. 2B with each of the GP ports 205-220 configured as E-ports and arranged as two pairs of trunked ports. This configuration would be used in a network as shown in FIG. 10A. In this embodiment, as in FIG. 4A, there is a relatively large buffered segment 405 in the RX_BUFFER 400 for ingress frames belonging to a specified path number or PN, which would indicate a particular VC from one GP circuit to another GP circuit. For purposes of this description in the case of the long haul configuration, ingress refers to the receive path for ports connected to long haul links, while egress refers to the receive path for ports connected to close or non-long haul links. Receive buffers for the specified virtual circuit of the relevant receiver in the GP circuit are allocated in segment 405 and advertised to the external transmitting device connected to the GP circuit. Preferably the segment 405 is the remainder of the RX_BUFFER 400 after providing space for small segment 410 described next.

The relatively small unbuffered segment 410 has a small number of allocated receive buffers but does not advertise or indicate any credits associated with those buffers. Segment 410 may be used for ingress frames belonging to all other VCs except that allocated for segment 405 and for all egress frames. The portion of the RX_BUFFER 400 reserved for the small segment 410 is based on a number of credits for the GP ports 205-220, the frame rates, the number of frames to be temporarily buffered, the number of RDYs sent and other relevant factors. In most cases the size is less than 100 kbytes.

Segment 410 can act as a temporary FIFO: receive buffers for the associated virtual circuits are allocated in the appropriate devices coupled to GP ports 205-220, and flow control between the externally transmitting device and these GP coupled devices ensures that the external device sends a frame to this segment only if the GP coupled device has a receive buffer for it. (This mechanism implements the Fibre Channel proscribed “credit” system of flow control.) A frame in segment 410 is forwarded to the appropriate GP port coupled device as soon as possible so that it does not block other frames behind it in the segment. Accordingly, segment 410 should have a higher priority for transmitting data through Fibre Channel port circuits 205-220 than segment 405. In addition, if the combined egress GP port data rate (see Table 6) is less than the combined ingress GP port data, segment 410 should be large enough to provide temporary buffering to accommodate for the speed difference.

FIG. 4C illustrates a configuration of the device 200 in the long haul configuration of FIG. 2B with each of the GP ports 205-220 configured as E-ports, but with only the two of the GP ports 205-220 connected over short links arranged as a pair of trunked ports. The remaining two of the GP ports 205-220 connected over a long haul link are not trunked. This configuration would be used in a network as shown in FIG. 10B. In this embodiment there are two relatively large buffered segments 405 and 410 in the RX_BUFFER 400, one each for ingress frames belonging to a specified PN, which would indicate a particular VC from one GP circuit to another GP circuit. Receive buffers for each of the specified virtual circuits of the relevant receivers in the GP circuits are allocated in segments 405 and 410 and advertised to the external transmitting devices connected to the GP circuits.

A relatively small unbuffered segment 415 has a small number of allocated receive buffers but does not advertise or indicate any credits associated with those buffers. Segment 415 may be used for ingress frames belonging to all other VCs except those allocated for segments 405 and 410 and for all egress frames.

Referring to FIG. 6B, in another configuration of device 200, each of GP ports 205-220 are configured as non-trunked F_Ports. This configuration would be used in a network as shown in FIG. 10C. In this embodiment, the memory associated with RX_BUFFER 600 may be partitioned into four segments 605, 610, 615 and 620. In this configuration, there are two bidirectional paths. Each bidirectional path uses two segments, one buffered and one unbuffered, with the buffered segment used for ingress frames and the unbuffered segment used for egress frames. In this configuration, segments 605 and 610 implement a unbuffered structure for egress frames and segments 615 and 620 implement a buffered structure for ingress frames. Thus segments 615 and 620 will be larger segments, while segments 605 and 610 will be smaller segments. (One of ordinary skill in the art will recognize that two or more of segments 605-620 may be physically embodied in a single memory device.)

While FIGS. 4B, 4C and 6B illustrate three configurations of device 200, one of ordinary skill in the art will recognize not all functions needed to implement a viable device have been shown. For example, it will be recognized that multiple clocking signals may be needed to implement device 200 but that the existence and variety of such clocking signals (forming different clock domains) would be known to those of ordinary skill. In addition, various other embodiments of device 200 may include additional circuits. Referring to FIG. 7B, for example, device 700 designed to implement the functions described herein may also include one or more circuits such as:

1. Flow control management circuit FLOW_CKT 705 for managing buffer-to-buffer credits (the Fibre Channel flow mechanism) for both the egress and ingress directions.

2. Statistics acquisition and monitoring circuit STAT_CKT 710 for recording frame traffic statistics such as, for example, the number of frames passing though a specified Fibre Channel port, the number of CRC errors occurring on frames passing through a specified port, etc.

3. Low-level Fibre Channel port interface LLI_GP 720 for communication with internal status and control registers within each Fibre Channel port circuit 205-220.

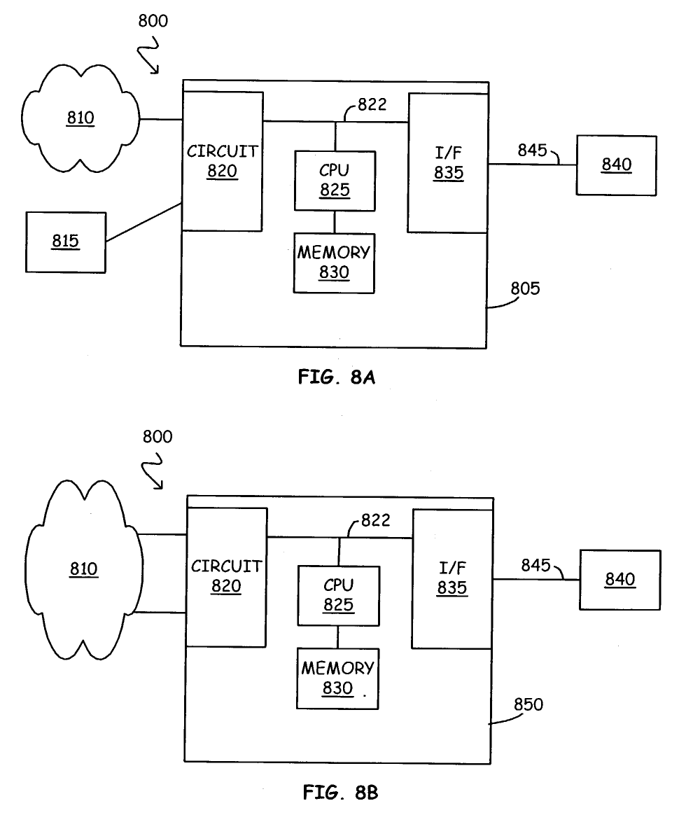

It will further be recognized that a device in accordance with the invention may be one component in a larger system. For example, FIG. 8A illustrates Fibre Channel network 800 having conversion unit 805 for coupling fabric 810 (itself comprising Fibre Channel switches, not shown) to high-speed device 815 (e.g., a XAUI compliant device). As shown, conversion unit 805 itself comprises circuit 820 in accordance with one of FIGS. 2A, 4A, 6A and 7A, CPU module 825, memory 830 and interface circuit 835 for communicating with control processor 840 via bus 845. CPU module 825 is typically used, along with local memory 830, to configure and initialize conversion unit 805 via bus 822, which may be a PCI bus. CPU module 825 and memory 830 may also be used during operations to query the state of conversion unit 805, obtain real-time operating data, for hardware and software debugging purposes and to provide other control functions for the circuit 820. Interface circuit 835 is connected to the bus 822 and provides an interface between an external control computer 840 and the conversion unit 805. Interface circuit 835 may provide one or more desired electrical interfaces such as, for example, RS-232, RS-422 or Ethernet connectivity to the bus 822. Accordingly, bus 845 may be any bus compatible with interface circuit 835. Control computer 840 provides administrator level control of the conversion unit 805.

Alternatively, the circuit 820 could be installed inside a Fibre Channel switch and connected internally to lower speed Fibre Channel ports contained inside the switch. For example, a card installed in the switch might have 16 ports in an all lower speed embodiment, but if circuit 820 is included on the same card, four of the ports would be internally connected to the circuit 820, so that the card would then have 12 lower speed ports and one high speed port interface.

FIG. 8B illustrates Fibre Channel network 800 having a long haul unit 850 for coupling portions of fabric 810 ((itself comprising Fibre Channel switches, not shown). As shown, conversion unit 850 itself comprises circuit 820 in accordance with one of FIGS. 2B, 4B, 6B and 7B, CPU module 825, memory 830 and interface circuit 835 for communicating with control processor 840 via bus 845.

Again alternatively, the circuit 820 could be installed inside a Fibre Channel switch and connected internally to local Fibre Channel ports contained inside the switch. For example, a card installed in the switch might have 16 shorter distance ports in one embodiment, but if circuit 820 is included on the same card, two of the ports would be internally connected to the circuit 820, so that the card would have 14 shorter distance ports and two longer distance ports.

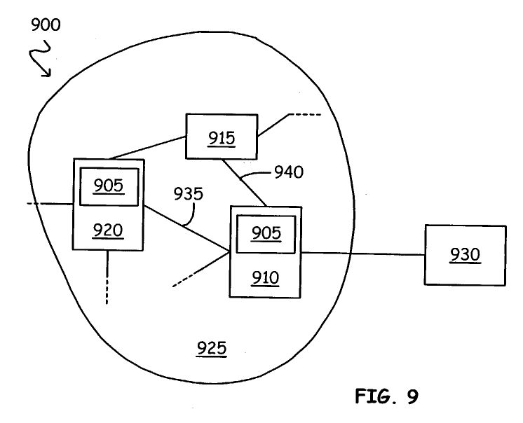

FIG. 9 shows Fibre Channel network 900 in accordance with another embodiment of the invention. In this embodiment, conversion circuit 905 is incorporated within one or more Fibre Channel switches (e.g., 910, 915, and 920) forming fabric 925. Conversion circuit 905 may embody a device in accordance with one of FIGS. 2, 4, 6 and 7 or conversion circuit 805. Accordingly, switch 910 (via conversion circuit 905) may couple device 930 (e.g., a XAUI compliant device) to fabric 925. Links 935 and 940 between switch 910 and switches 920 and 915, respectively, are preferably trunked Fibre Channel links, but could be single Fibre Channel links.

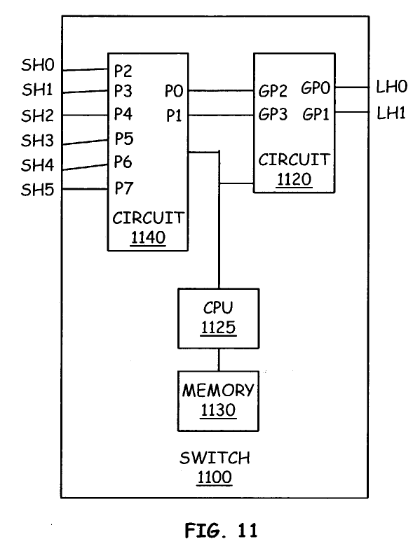

An exemplary switch 1100 used for long haul cases is shown in FIG. 11. A circuit 1120, effectively device 200, is connected to a CPU 1125, which is also connected to memory 1130. The circuit 1120 and the CPU 1125 are also connected to a circuit 1140. Circuit 1140 is an exemplary eight port mini-switch, such as the one shown in U.S. patent application Ser. No. 10/123,996 entitled “Fibre Channel Zoning by Device Name in Hardware,” by Ding-Long Wu, David C. Banks and Jieming Zhu, filed Apr. 17, 2000, which is hereby incorporated by reference.

Switch 1100 has eight ports, LH0 and LH1 being long haul ports and SH0-SH5 being short haul ports. Circuit 1120 has GP0 and GP1 ports connected to LH0 and LH1 ports. Circuit 1120 has GP2 and GP3 ports connected to the P0 and P1 ports of circuit 1140, preferably in a trunked fashion. The P2-P7 ports of circuit 1140 are connected to the SH0-SH5 ports.

The switch 1100 could be configured in a network as shown in FIG. 10A. Two switches 1100A and 1100B have their LH0 and LH1 ports connected, preferably in a trunked configuration. Each switch 1100A and 1100B then as its SH0 and SH1 ports connected to servers and storage units.

In an alternate arrangement shown in FIG. 10B, three switches 1100A-C are interconnected. In the illustrated case, switches 1100A and 1100B have their LH0 ports connected while switches 1100B and 1100C have their LH1 ports connected. Each switch 1100A-C is shown as being connected to servers and storage units.

A third arrangement is shown in FIG. 10C. Here a switch 1180 is used. Switch 1180 differs from switch 1100 by not including a circuit 1140. Thus the ports on switch 1180 match those of circuit 1120. In the illustrated case, a server 1182 and a storage device 1184 are connected to switch 1180 over long haul links, while a server 1186 and a storage device 1188 are connected using short haul links.

Various changes in the illustrated embodiments are possible without departing from the scope of the claims. For example, devices in accordance with any of FIGS. 2 through 9 may be implemented in a number of ways including, but not limited to, Application Specific Integrated Circuits (ASICs), Field Programmable Gate Arrays (FPGAs), one or more operatively coupled microcontrollers or microprocessors and discrete logic, or a combination of one or more of these technologies. In addition, buffer circuits in accordance with 230, 245, 400 and 600 may be implemented using any convenient storage technology including, but not limited to random access memories (RAMs), Flash devices, Electrically Erasable Programmable Read Only Memory (EEPROM) devices and Programmable Read Only Memory (PROM) devices. In addition, acts in accordance with FIG. 5 may be performed by a programmable control device executing instructions organized into a program module. A programmable control device may be a single computer processor, a plurality of computer processors coupled by a communications link, or a custom designed state machine. Custom designed state machines may be embodied in a hardware device such as a printed circuit board comprising discrete logic, integrated circuits, or specially designed application specific integrated circuits (ASICs). Storage devices suitable for tangibly embodying program instructions include all forms of nonvolatile memory including, but not limited to: semiconductor memory devices such as Electrically Programmable Read Only Memory (EPROM), Electrically Erasable Programmable Read Only Memory (EEPROM), and flash devices.

Thus, while the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

What is claimed is:

1. A device, comprising:
a plurality of Fibre Channel ports, at least one of the plurality of Fibre Channel ports for connection over a longer distance link and at least one of the plurality of Fibre Channel ports for connection over a shorter distance link;
first storage communicatively coupled to the plurality of Fibre Channel ports and adapted to receive frame data from the plurality of Fibre Channel ports; and
second storage communicatively coupled to the plurality of Fibre Channel ports, connected to the first storage and adapted to provide frame data to the plurality of Fibre Channel ports, the second storage including a first segment for storing frame data for a Fibre Channel port connected over a longer distance link and a second segment for storing any remaining frame data.

2. The device of claim 1, wherein the first segment is substantially larger than the second segment.

3. The device of claim 1, wherein said second storage further includes a third segment for storing frame data for a Fibre Channel port connected over a long distance link.

4. The device of claim 3, wherein the first and third segments are substantially larger than the second segment.

5. The device of claim 3, wherein the second storage further includes a fourth segment for storing frame data for a Fibre Channel port connected over a shorter distance link and wherein the second segment thus stores frame data for a Fibre Channel port connected over a shorter distance link.

6. The device of claim 5, wherein the first and third segments are substantially larger than the second and fourth segments.

7. The device of claim 1, wherein said first segment stores frame data only for a first virtual circuit.

8. The device of claim 1, wherein there are at least two Fibre Channel ports trunked over longer distance links.

9. The device of claim 8, wherein there are at least two Fibre Channel ports trunked over shorter distance links.

10. The device of claim 1, further comprising:
third storage;
an interface circuit; and
a processor circuit operatively coupled to the third storage and the second interface circuit, the processor circuit adapted to communicate with one or more devices through the second interface circuit and to initialize the plurality of Fibre Channel ports.

11. The device of claim 1, further comprising:
a first interface circuit adapted to receive and transmit frame data, the second storage further adapted to receive frame data from the first interface circuit and the first storage further adapted to provide frame data to the first interface circuit;
a first control circuit adapted to route frame data from the first storage to at least two of the Fibre Channel ports, and for routing frame data from the second storage to at least one of the Fibre Channel ports, wherein frame data is routed from the first storage to the at least two Fibre Channel ports in the same order it was received at the first storage as appropriate for each of the at least two Fibre Channel ports;
a second control circuit adapted to route frame data from each of the plurality of Fibre Channel ports to the second storage and for routing frame data from the second storage to the first interface circuit, wherein frame data is routed from the second storage to the first interface circuit in the same order it was received at the second storage from the plurality of Fibre Channel ports; and
a circuit for controllably selecting the first and second storage to be connected to each other or to the first interface circuit.

12. A Fibre Channel switch, comprising:
a plurality of Fibre Channel ports, at least one of the plurality of Fibre Channel ports for connection over a longer distance link and at least one of the plurality of Fibre Channel ports for connection over a shorter distance link;
first storage communicatively coupled to the plurality of Fibre Channel ports and adapted to receive frame data from the plurality of Fibre Channel ports; and
second storage communicatively coupled to the plurality of Fibre Channel ports, connected to the first storage and adapted to provide frame data to the plurality of Fibre Channel ports, the second storage including a first segment for storing frame data for a Fibre Channel port connected over a longer distance link and a second segment for storing any remaining frame data.

13. The switch of claim 12, wherein the first segment is substantially larger than the second segment.

14. The device of claim 12, wherein said first segment stores frame data only for a first virtual circuit.

15. The switch of claim 12, wherein said second storage further includes a third segment for storing frame data for a Fibre Channel port connected over a longer distance link.

16. The switch of claim 15, wherein the first and third segments are substantially larger than the second segment.

17. The switch of claim 15, wherein the second storage further includes a fourth segment for storing frame data for a Fibre Channel port connected over a shorter distance link and wherein the second segment thus stores frame data for a Fibre Channel port connected to a shorter distance link.

18. The switch of claim 17, wherein the first and second segments are substantially larger than the second and fourth segments.

19. The switch of claim 12, wherein there are at least two Fibre Channel ports trunked over longer distance links.

20. The switch of claim 19, wherein there are at least two Fibre Channel ports trunked over shorter distance links.

21. The switch of claim 12, further comprising:
third storage;
an interface circuit; and
a processor circuit operatively coupled to the third storage and the second interface circuit, the processor circuit adapted to communicate with one or more devices through the second interface circuit and to initialize the plurality of Fibre Channel ports.

22. The switch of claim 12, further comprising:
a first interface circuit adapted to receive and transmit frame data, the second storage further adapted to receive frame data from the first interface circuit and the first storage further adapted to provide frame data to the first interface circuit;
a first control circuit adapted to route frame data from the first storage to at least two of the Fibre Channel ports, and for routing frame data from the second storage to at least one of the Fibre Channel ports, wherein frame data is routed from the first storage to the at least two Fibre Channel ports in the same order it was received at the first storage as appropriate for each of the at least two Fibre Channel ports;
a second control circuit adapted to route frame data from each of the plurality of Fibre Channel ports to the second storage and for routing frame data from the second storage to the first interface circuit, wherein frame data is routed from the second storage to the first interface circuit in the same order it was received at the second storage from the plurality of Fibre Channel ports; and
a circuit for controllably selecting the first and second storage to be connected to each other or to the first interface circuit.

23. A Fibre Channel fabric, comprising:
a first Fibre Channel switch; and
a second Fibre Channel switch connected to the first switch, the second switch including:
a plurality of Fibre Channel ports, at least one of the plurality of Fibre Channel ports for connection over a longer distance link and at least one of the plurality of Fibre Channel ports for connection over a shorter distance link;
first storage communicatively coupled to the plurality of Fibre Channel ports and adapted to receive frame data from the plurality of Fibre Channel ports; and
second storage communicatively coupled to the plurality of Fibre Channel ports, connected to the first storage and adapted to provide frame data to the plurality of Fibre Channel ports, the second storage including a first segment for storing frame data for a Fibre Channel port connected over a longer distance link and a second segment for storing any remaining frame data.

24. The fabric of claim 23, wherein the first segment is substantially larger than the second segment.

25. The fabric of claim 23, wherein said first segment stores frame data only for a first virtual circuit.

26. The fabric of claim 23, wherein said second storage further includes a third segment for storing frame data for a Fibre Channel port connected over a longer distance link.

27. The fabric of claim 26, wherein the first and second segments are substantially larger than the second segment.

28. The fabric of claim 26, wherein the second storage further includes a fourth segment for storing frame data for a Fibre Channel port connected over a shorter distance link, and wherein the second segment thus stores frame data for a Fibre Channel port connected to a shorter distance link.

29. The fabric of claim 28, wherein the first and second segments are substantially larger than the second and fourth segments.

30. The fabric of claim 23, wherein there are at least two Fibre Channel ports trunked over longer distance links.

31. The fabric of claim 30, wherein there are at least two Fibre Channel ports trunked over shorter distance links.

32. The fabric of claim 23, the second switch further including:
third storage;
an interface circuit; and
a processor circuit operatively coupled to the third storage and the second interface circuit, the processor circuit adapted to communicate with one or more devices through the second interface circuit and to initialize the plurality of Fibre Channel ports.

33. The fabric of claim 23, the second switch further including:
a first interface circuit adapted to receive and transmit frame data, the second storage further adapted to receive frame data from the first interface circuit and the first storage further adapted to provide frame data to the first interface circuit;
a first control circuit adapted to route frame data from the first storage to at least two of the Fibre Channel ports, and for routing frame data from the second storage to at least one of the Fibre Channel ports, wherein frame data is routed from the first storage to the at least two Fibre Channel ports in the same order it was received at the first storage as appropriate for each of the at least two Fibre Channel ports;
a second control circuit adapted to route frame data from each of the plurality of Fibre Channel ports to the second storage and for routing frame data from the second storage to the first interface circuit, wherein frame data is routed from the second storage to the first interface circuit in the same order it was received at the second storage from the plurality of Fibre Channel ports; and
a circuit for controllably selecting the first and second storage to be connected to each other or to the first interface circuit.

34. A Fibre Channel network, comprising:
a host;
a storage unit;
a first Fibre Channel switch coupled to the host and the storage unit; and
a second Fibre Channel switch coupled to the host and the storage unit and connected to the first switch, the second switch including:
a plurality of Fibre Channel ports, at least one of the plurality of Fibre Channel ports for connection over a longer distance link and at least one of the plurality of Fibre Channel ports for connection over a shorter distance link;
first storage communicatively coupled to the plurality of Fibre Channel ports and adapted to receive frame data from the plurality of Fibre Channel ports; and
second storage communicatively coupled to the plurality of Fibre Channel ports, connected to the first storage and adapted to provide frame data to the plurality of Fibre Channel ports, the second storage including a first segment for storing frame data for a Fibre Channel port connected over a longer distance link and a second segment for storing any remaining frame data.

35. The network of claim 34, wherein the first segment is substantially larger than the second segment.

36. The network of claim 34, wherein said segment stores frame data only for a first virtual circuit.

37. The network of claim 34, wherein said second storage further includes a third segment for storing frame data for a Fibre Channel port connected over a longer distance link.

38. The network of claim 37, wherein the first and second segments are substantially larger than the second segment.

39. The network of claim 37, wherein the second storage further includes a fourth segment for storing frame data for a Fibre Channel port connected over a shorter distance link, and wherein the second segment thus stores frame data for a Fibre Channel port connected to a shorter distance link.

40. The network of claim 39, wherein the first and second segments are substantially larger than the second and fourth segments.

41. The network of claim 34, wherein there are at least two Fibre Channel ports trunked over longer distance links.

42. The network of claim 41, wherein there are at least two Fibre Channel ports trunked over shorter distance links.

43. The network of claim 34, the second switch further including:
third storage;
an interface circuit; and
a processor circuit operatively coupled to the third storage and the second interface circuit, the processor circuit adapted to communicate with one or more devices through the second interface circuit and to initialize the plurality of Fibre Channel ports.

44. The network of claim 34, the second switch further including:
a first interface circuit adapted to receive and transmit frame data, the second storage further adapted to receive frame data from the first interface circuit and the first storage further adapted to provide frame data to the first interface circuit;
a first control circuit adapted to route frame data from the first storage to at least two of the Fibre Channel ports, and for routing frame data from the second storage to at least one of the Fibre Channel ports, wherein frame data is routed from the first storage to the at least two Fibre Channel ports in the same order it was received at the first storage as appropriate for each of the at least two Fibre Channel ports;
a second control circuit adapted to route frame data from each of the plurality of Fibre Channel ports to the second storage and for routing frame data from the second storage to the first interface circuit, wherein frame data is routed from the second storage to the first interface circuit in the same order it was received at the second storage from the plurality of Fibre Channel ports; and
a circuit for controllably selecting the first and second storage to be connected to each other or to the first interface circuit.
